(19) United States
(12) Patent Application Publication
(10) Pub. No.: US 2007/0039938 A1
(43) Pub. Date: Feb. 22, 2007

(54) Fault tolerant element and combination with fault tolerant circuit

(76) Inventors: Kevin B. Peck, Sonora, CA (US); Pontus K.H. Nilsson, Oakdale, CA (US)

Correspondence Address: DRINKER BIDDLE & REATH (DC), 1500 K STREET, N.W., SUITE 1100, WASHINGTON, DC, 20005-1209, US

(21) Appl. No.: 11/505,907

(22) Filed: Aug. 18, 2006

Related U.S. Application Data
(60) Provisional application No. 60/709,464, filed on Aug. 19, 2005.

(51) Int. Cl. H05B 3/00; H05B 1/00; H05B 11/00

(52) U.S. Cl. 219/201

(57) ABSTRACT

An arrangement of a heating element into divided zones of intermingled groups is provided. The heating element arranged circumferentially about an exterior of a heating zone of a furnace, in combination with a fault tolerant circuit that provides for the same power characteristics to an assembly of electrical resistive elements wired in parallel as to the assembly as wired in series is also provided. Redundancy and fault tolerance is provided to a heating process using the combination because the circuitry permits remaining load elements to continue to operate should one or more load elements fail and the intermingled arrangement maintains a balanced application of heat.

### RELATED APPLICATION DATA

This application claims priority under 35 U.S.C. §119(e) to U.S. Provisional Application No. 60/709,464, filed on Aug. 19, 2005, the entire disclosure of which is considered as being part of the disclosure of the present application and is hereby incorporated by reference therein.

### FIELD

The present invention relates to an arrangement of resistance heating elements and a combination of an arrangement of resistance heating elements and an electrical circuit for same. More particularly, exemplary embodiments are directed to an arrangement of intermingled resistance heating elements per se, a heating furnace having arrangement of intermingled resistance heating elements, and an arrangement of intermingled resistance heating elements with a fault tolerant electrical circuit.

### BACKGROUND

In the discussion of the background that follows, reference is made to certain structures and/or methods. However, the following references should not be construed as an admission that these structures and/or methods constitute prior art. Applicant expressly reserves the right to demonstrate that such structures and/or methods do not qualify as prior art.

It is common in the semiconductor industry to utilize compact resistive heating element assemblies to heat a material to a desired temperature. An example of such an application is the heating of a hydrogen and oxygen gas stream in order to produce a high-purity steam.

These heating element assemblies are usually quite small in size and are designed to run from standard 120V AC nominal voltage. The combination of the physical size limitations and high voltage lead to the selection of relatively small wire diameters for the resistance heater. The use of small wire diameters can in turn lead to more frequent failures of the elements than is desirable.

Resistance heating elements and assemblies are typically designed with one or more active electrical segments that are connected in some form of series/parallel electrical circuit in order to create a “zone” of heating control. For example, FIG. 1 depicts, in a laid out arrangement, an assembly 100 of heating elements 102 for a cylindrical application. The assembly 100 includes a first subzone 110 of heating elements 102 and a second subzone 120 of heating elements 102. The heating. elements 102 of each subzone are connected by connectors 104 to form a continuous circuit path for applied electricity. The control circuit for a subzone can be connected to the circuit path at its extreme ends, as shown by connections 106 and 108 in FIG. 1. The circuit path is limited to a particular subzone. For example, the heating elements connected to form a first circuit path 112 are all located in the first subzone 110.

In many cases, the above-described heating element assemblies consist of two half-sections wired in series to obtain the desired electrical characteristics. FIG. 1 depicts a series connection of a heating elements in a first subzone 110 and a second subzone 120. If the heating elements were wired in parallel, for example, the resistance would be relatively low; and more power would be required to heat the elements to proper temperatures. One consequence of this typical in-series connection is that when one half of the element fails, the entire unit is disabled or, alternatively, the failure of one heating subzone produces unbalanced heat profile in the furnace, because the subzones are spatially separated. The failure of the heating element assembly during a process run can generate a potentially unsafe conditions and/or can cause a heating profile to be skewed and can lead to the workpieces of the process run in the furnace at that time being scrapped or requiring reworking. Scrapped lots and rework have obvious detrimental efficiency and economic implications.

In the specific example shown in FIG. 1, the subzone of the heating element is two ½ cylinders electrically connected as one cylindrical zone of heat. The nature of the electrical connections (series within each half in this case) produces an undesirable effect if one of the electrical segments fails. A failure within the subzone causes one entire ½ cylinder to loose power, which in turn can cause the control system to stop functioning correctly. If there is a process actively being performed in the heating element assembly at the time of the failure, there is a risk that the process will not produce the desired results and that non-conforming product, or unsafe conditions could result.

In light of the above, it would be advantageous to change the connection of the two halves to a parallel configuration, so as to avoid the total failure from the failure of a single heating element. Furthermore, it would be advantageous to change the arrangement of heating subzones so that the failure of one portion of the subzone does not unbalance the heat profile in the furnace. Finally, it would be advantageous to combine both a connection of the two halves to a parallel configuration and an arrangement of heating subzones so that the failure of one subzone does not unbalance the heat profile in the furnace.

Changing from a series connection to a parallel wiring configuration normally involves changing the heating element wire to a smaller gauge so that the parallel connection retains the same electrical characteristics as the series connection, which is necessary in order to be able to use the same power supply controls.

This problem can be described by reference to the following expressions and calculations.

Assuming a series and parallel connection of a two-section heating element assembly, the total resistance for the series connection is:
Rₛ=R₁+R₂
where Rₛ is the total resistance of the series connection, R₁ is the resistance of the first section, and R₂ is the resistance of the second section. The total resistance of the arrangement wired in parallel is:
1/Rₚ=1/R₁+1/R₂
where Rₚ is the total resistance of the parallel connection. Assuming that the resistance of the first and second sections are the same (R₁=R₂), the above expressions can be simplified as follows:
Rₛ=2R
1/Rₚ=2/R
Rₚ=R/2

Thus, in order to render the resistance of the series and parallel connections equal and from the above:
Rₛ=Rₚ
2Rₛ=Rₚ/2
Rₚ=4×Rₛ
Thus, in the above example, the resistance must be increased by four-fold in order to switch from a series configuration to a parallel configuration.

According to the following expression it is known that resistance is inversely proportional to the gauge of a round wire:
R=ρL/A=ρL/πr²
where ρ is the resistivity constant, L is the length of the wire, A is the cross-sectional area of the wire, and r is the radius of the wire. Thus, a decrease in the cross-sectional area of the wire will result in the desired increase in resistance.

However, as mentioned above, resorting to smaller diameter heating element wires can greatly reduce the life and reliability of the element assembly. Therefore, it would be desirable to provide a mechanism to permit the parallel connection of a plurality of resistive elements without resorting to reduction in the gauge of the wires.

### SUMMARY OF THE INVENTION

Disclosed arrangement of heating elements, heating furnaces and combinations of heating elements and control circuits provide the same power characteristics to a plurality of elements wired in parallel as provided to a corresponding assembly wired in series such that redundancy and fault tolerance is provided to a heating process using the combination because the circuitry permits remaining load elements to continue to operate should one or more load elements fail and the intermingled arrangement maintains a balanced application of heat

An exemplary assembly of heating elements comprises a first plurality of heating elements connected in series forming a first subzone, and a second plurality of heating elements connected in series forming a second subzone, wherein the heating elements of the first subzone are intermingled with the heating elements of the second subzone.

An exemplary heating furnace comprises an assembly of heating elements including a first plurality of heating elements connected in series forming a first subzone, and a second plurality of heating elements connected in series forming a second subzone, wherein the heating elements of the first subzone are intermingled with the heating elements of the second subzone, and wherein the first plurality of heating elements and the second plurality of heating elements are arranged about a process area of the heating furnace.

An exemplary combination for a heating assembly in a heating furnace, comprises a fault tolerant element including an assembly of heating elements including a first plurality of heating elements connected in series forming a first subzone and a second plurality of heating elements connected in series forming a second subzone, wherein the heating elements of the first subzone are intermingled with the heating elements of the second subzone, and a fault tolerant control circuit including an electrical power source for providing electrical power to the first subzone and the second subzone, wherein the first subzone and the second subzone are connected in parallel to each other, and a plurality of power splitters for dividing the electrical power source into separate and equal power subsources such that there is one power splitter and one power subsource for each of the first subzone and the second subzone, wherein a time averaged sum of the power provided to the first subzone and the second subzone is equal to the power of the electrical power source.

An exemplary method for dividing an electrical resistive load among a plurality of load elements in parallel, comprises providing electrical power to a plurality of load elements, wherein the plurality of load elements are connected in parallel to each other, and dividing the electrical power into separate and equal power subsources such that there is one power splitter and one power subsource for each load element, wherein a time averaged sum of the power provided to the plurality of load elements is equal to the power of the electrical power source, and wherein the plurality of load elements include a first subzone and a second subzone, the first subzone including a first plurality of heating elements connected in series and the second subzone including a second plurality of heating elements connected in series.

It is to be understood that both the foregoing general description and the following detailed description are exemplary and explanatory and are intended to provide further explanation of the invention as claimed.

### BRIEF DESCRIPTION OF THE DRAWING

The following detailed description can be read in connection with the accompanying drawings in which like numerals designate like elements and in which:

FIG. 1 depicts, in a laid out arrangement, an assembly of heating elements for a cylindrical application with heating elements forming spatially separated heating subzones.

FIG. 2A depicts, in laid out arrangement, an assembly of heating elements for a cylindrical application with heating elements forming spatially intermingled heating subzones.

FIG. 2B depicts, in laid out arrangement, an assembly of heating elements for a planar application with heating elements forming spatially intermingled heating subzones.

FIG. 2C depicts, in laid out arrangement, an assembly of heating elements for a planar application with heating elements forming spatially intermingled heating subzones.

FIG. 3, consisting of FIGS. 3A-3G, is a graphical representation by sine waves of impedance matching of loads in parallel to draw the same power through each load element as in a series configuration.

FIG. 4 is a schematic illustration of a control circuit constructed according to exemplary embodiments, and optional surrounding components of an assembly connected thereto.

FIG. 5 is a conceptional schematic illustration of a circuit for proportionally dividing an electrical load among a plurality of load sections according to exemplary embodiments.

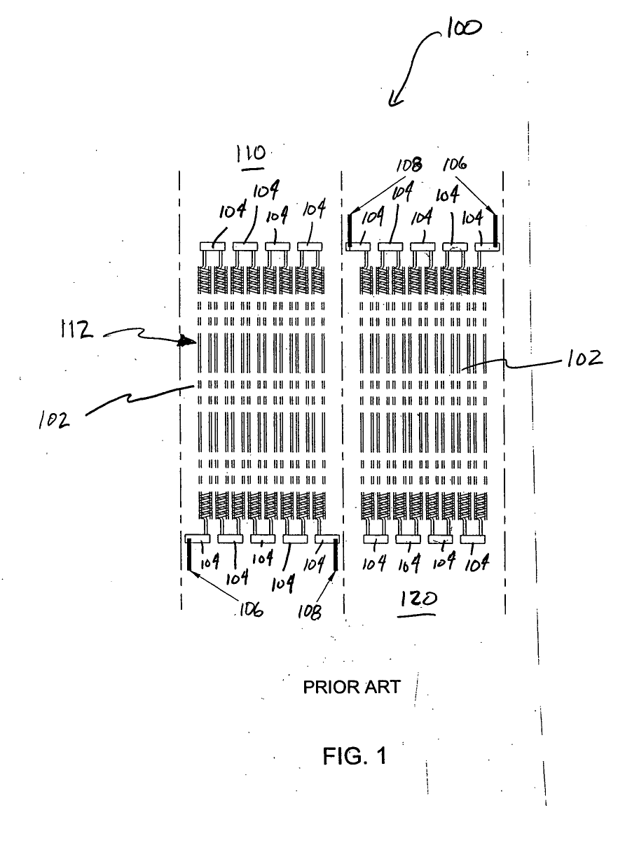

### DETAILED DESCRIPTION

Exemplary embodiments disclosed herein provide, among other things, a more robust heating element assembly that is less prone to failure, wherein failure of even one section of heating elements does not cause failure of the entire assembly. Exemplary embodiments disclosed herein provide, among other things, for potentially significant improvement in the operative lifetimes of such assemblies, and potentially significant reduction in scrap and rework rates when compared with conventional heating element assemblies.

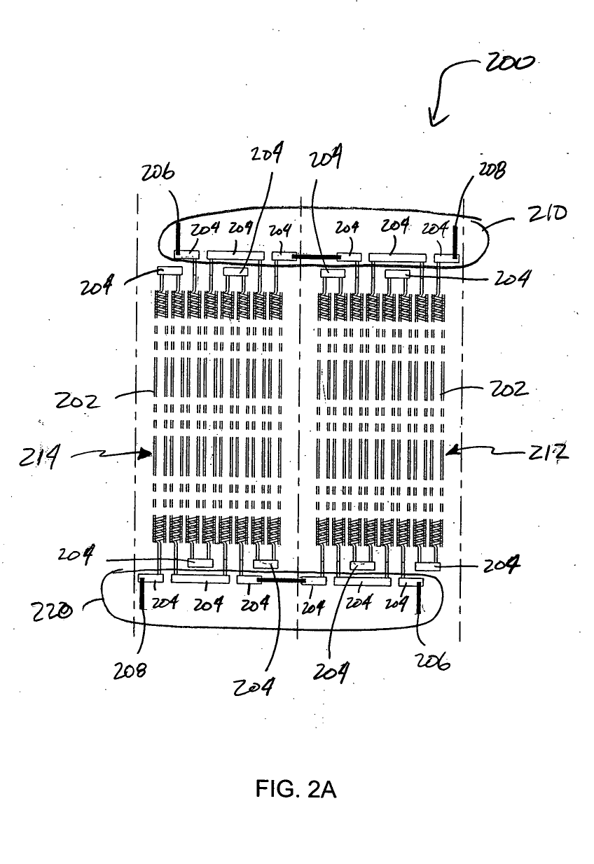

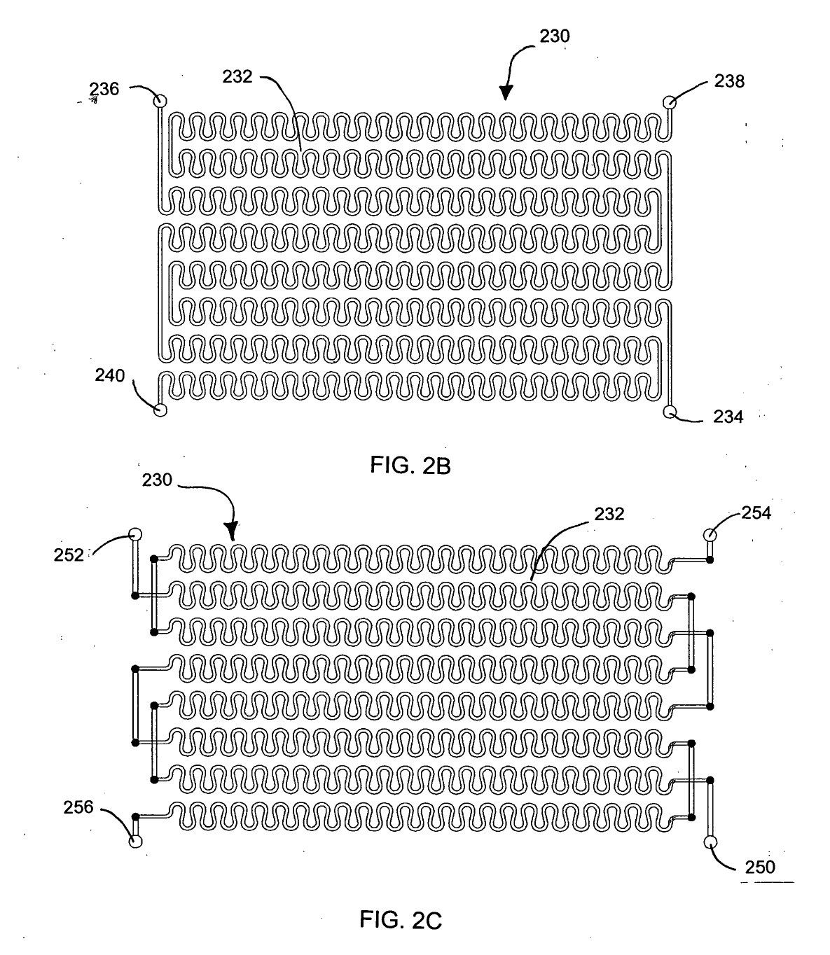

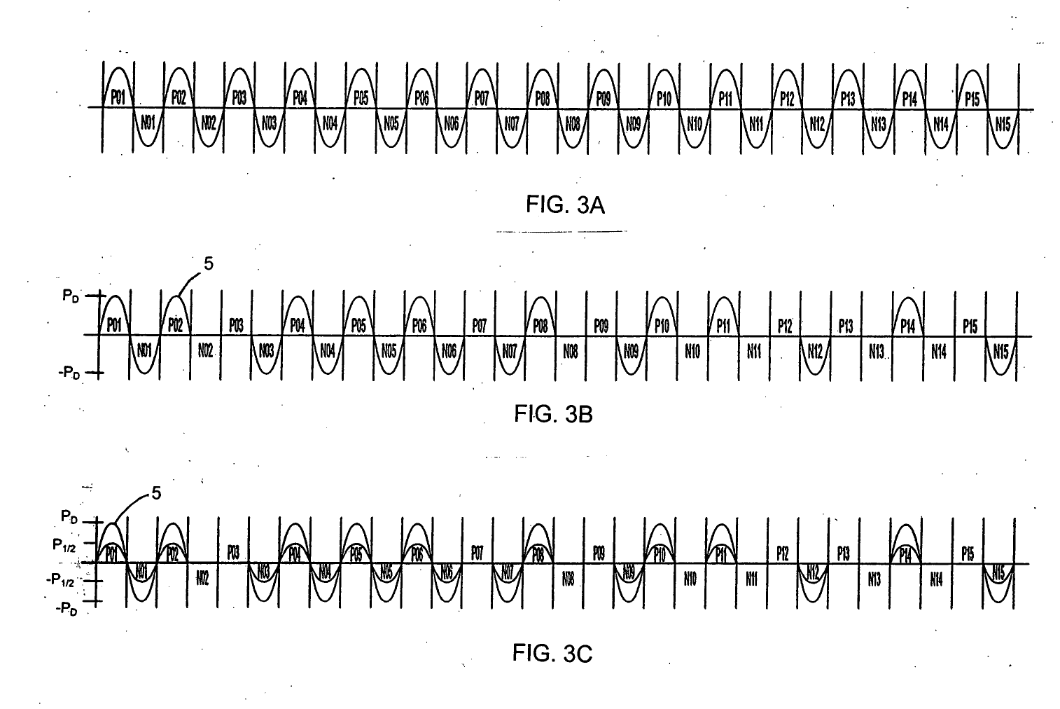

FIG. 2A depicts, in a laid out arrangement, an exemplary assembly 200 of heating elements 202 for a cylindrical application. The assembly 200 has a zone of heating control comprising a first subzone 210 of heating elements 202 and a second subzone 220 of heating elements 202. In FIG. 2A, the subzones are identified by indicating the connectors joining the heating elements of each respective subzone, but it is to be understood that the subzone spatially also includes the areas associated with the heating elements themselves. In exemplary embodiments, the zone of heating control can have any desired number of subzones, and the two subzones depicted are merely for illustration.

The heating elements 202 of each subzone are connected by connectors 204 to form a continuous circuit path for applied electricity. The control circuit for a subzone can be connected to the circuit path at its extreme ends, as shown by connections 206 and 208 in FIG. 2A. The circuit path is limited to a particular subzone. For example, the heating elements connected to form a first circuit path 212 are all located in the first subzone 210 and the heating elements connected to form a second circuit path 214 are all located in the second subzone 220. The heating elements forming the first subzone 210 are intermingled with the heating elements forming the second subzone 210. Here, the intermingled arrangement is interdigitated and regular with two runs of heating elements (each of length L) from one subzone alternating with two runs of heating elements (each of length L) from a second subzone.

The heating elements in each of the first subzone and the second subzone are wired in series within the respective subzone. However, the electrical connection of each of the first subzone and the second subzone to a control circuit (via connections 206 and 208) is in parallel.

Here, the division into subzones and intermingling the subzones results in a single failure causing a minimal loss of uniformity and insures the overall zone can continue to operate for some time after the failure. The failed subzone can be replaced or repaired at a latter time.

Although depicted here as cylindrical zone, the arrangement of heating elements into subzones and subzones into a zone can be in any geometry, including flat heating sections or helical sections, each of which can be intermingled. For example, interposed spiral-wrapped heating elements and interposed helical coils are contemplated. For example two semi-cylinders with coiled wire in eight segments axially down the length of each cylinder.

A “zone” of heating control can be any spatial area of an assembly of heating elements that are controlled as a unit to control the heat produced. An apparatus, such as a furnace, can have more than one zone of heating control, each called a subzone.

In cylindrical applications, the heating elements are arranged circumferentially and the subzone of heating control can be a portion of the circumferentially arranged heating elements. For example, in an exemplary embodiment the heating elements are arranged circumferentially to form a cylinder and the subzone of heating control is a portion of that cylinder, such as a semi-cylinder or a quarter cylinder. In other examples, the heating elements are arranged circumferentially to form a non-circular geometric body or a parallelepiped body.

In planar applications, supply lines of the heating elements can be independently and spatially alternatingly connected to return lines of the heating elements. Alternatively for the planar application, one or more independent circuits of heating elements can be symmetrically or randomly intermingled in a common plane. The entire circuit can be in a common plane, or portions of the circuit, such as a major portion of the circuit, can be in a common plane. In the planar application, the subzone of heating control can be a portion of the planar arranged heating elements.

FIGS. 2B and 2C each schematically illustrate an exemplary assembly 230 of heating elements 232 for a planar application. In FIG. 2B, the heating elements 232 are connected, independently by subzone, to supply lines 234, 236 and are connected, independently by subzone, to return lines 238, 240. Alternatively, the subzones can be connected to a common return line. In FIG. 2C, the heating elements 232 are connected independently by subzone, to supply lines 250, 252 and are connected, independently by subzone, to return lines 254, 256. The path of the heating elements of each subzone are contained within a common plane and the subzones are spatially intermingled.

In any geometric configuration, the path of the emitter, e.g., a portion or all of the path of the heating elements from supply lines to return lines, can have a spatially varying arrangement, such as a sinusoidal path as disclosed in U.S. Pat. No. 4,596,922, the disclosure of which is incorporated herein. For example, the exemplary assemblies 230 in FIGS. 2B and 2C depict sinusoidal paths.

Also, other examples of subzones of heating control include radially or axially separated portions, combinations and mixtures of radially and axially separated portions, and intermingled arrangements. In a simple example of an intermingled arrangement, the heating elements of one subzone are interdigitated with the heating elements of a second subzone. Interdigitation can be in a regular pattern, e.g., alternating same number of heating elements from each subzone of control, in an axial, radial or circumferential direction or an irregular pattern, e.g., alternating non-equal number of heating elements from each subzone of control, in an axial, radial or circumferential direction.

In order to maintain the same net power output to the process being actively performed by the heating element assembly during a failure of a subzone, the power supply can be configured to increase the supply to the remaining operating subzones. This can insure the zone can reach or maintain the desired operating temperature after a subzone fails. U.S. patent application Ser. No. 10/671,777, the entire contents of which are incorporated herein, discloses a fault tolerant control circuit that can be used in combination with the assembly of heating elements disclosed herein to provide such power supply.

An exemplary fault tolerant control circuit comprises an electrical power source for providing electrical power to a plurality of resistive load elements, wherein the plurality of load elements are connected in parallel to each other, and a plurality of power splitters for dividing the electrical power source into separate and equal power subsources such that there is one power splitter and one power subsource for each load element, wherein a time averaged sum of the power provided to the plurality of load elements is equal to the power of the electrical power source. Such an exemplary circuit divides an electrical resistive load among a plurality of load elements in parallel.

According to one aspect, exemplary embodiments provide a circuit permitting an electric heating load to be divided among a plurality of sections for redundancy and then restored to the same effective average power at a given power input level. Incoming power normally destined to be delivered to two series-connected resistive heating loads or element sections is time proportionally distributed on a per half wave cycle basis to the halves of the heating loads. The circuit can be also be configured for other multiples of element sections as well as skipping a number of cycles between each cycle. Such embodiments balance the power over the collection of heating elements and permit the remaining elements to continue operation in the event one or more elements fail.

Embodiments provide a circuit for presenting a fractional wave of alternating current (AC) to each of a plurality of devices connected thereto. According to one embodiment, the circuit comprises a rectifier. According to a further embodiment, the circuit comprises at least one semiconductor device. According to yet another embodiment, the circuit comprises at least one silicon control rectifier (SCR). According to a further embodiment, the circuit comprises a pair of SCR's. According to a further embodiment, the circuit comprises a SCR module. According to another embodiment the circuit comprises a plurality of terminals. According to yet another embodiment, the fractional wave comprises a half wave.

According to another aspect, exemplary embodiments provide for an assembly comprising a power controller, a circuit, and a plurality of resistive heating elements. According to one embodiment, the power controller is adapted for connection to a standard 120V AC power source with nominal voltage. “Standard nominal voltage” is intended to include a standard voltage range for 120V devices, such as a range of 100V to 125V. Embodiments also provide for standard nominal 220V power supplies and even DC power supplies without detracting from the novel features. According to another embodiment, the circuit provides for presenting a fractional wave of alternating current to each of a plurality of devices connected thereto. According to one embodiment, the circuit comprises a rectifier. According to a further embodiment, the circuit comprises at least one semiconductor device.

According to yet another embodiment, the circuit comprises at least one silicon control rectifier (SCR). According to a further embodiment, the circuit comprises a pair of SCR's. According to a further embodiment, the circuit comprises a SCR module. According to another embodiment the circuit comprises a plurality of terminals. According to yet another embodiment, the fractional wave comprises a half wave. According to an additional embodiment, the controller is electrically connected to a first terminal of the circuit, and the plurality of heating elements are electrically connected to a second, and possible additional, terminal(s) of the circuit. According to another embodiment, one-half of the total AC supply voltage is conveyed to each of the pair of heating elements; and, subsequently, the AC supply voltage is limited to fifty percent (50%) of duty cycle. According to another embodiment, when for example the circuit provides for three load elements, the supply voltage is limited to thirty three percent of duty cycle. In such a manner, any number of load elements can be accommodated by exemplary embodiments.

According to yet another embodiment, the plurality of electrical heating elements are connected to the power supply in parallel in such a manner that if one or more elements fail or become out of specification, the remaining heating elements can continue to function properly. According to a further embodiment, the wires of the electrical heating elements are of the same gauge. According to yet a further embodiment, current is drawn evenly from the power source on both the negative and positive sides of the alternating current cycle. According to an additional embodiment, the circuit is further designed to generate an alarm signaling failure and/or an out of specification condition. According to a further embodiment, the circuit includes components for connecting and communicating with one or more thermocouples.

An exemplary embodiment is directed to a circuit to divide an electrical resistive load among a plurality of load elements in parallel, including an electrical power source for providing electrical resistive power to a plurality of load elements, wherein the plurality of load elements are connected in parallel to each other; and a plurality of power splitters for dividing the electrical power source into separate and equal power subsources such that there is one power splitter and one power subsource for each load element, wherein the power provided to each of the plurality of load elements is equal to the power of the electrical power source.

An additional embodiment is directed to a method for dividing an electrical resistive load among a plurality of load elements in parallel, including providing electrical power to a plurality of load elements, wherein the plurality of load elements are connected in parallel to each other; and dividing the electrical power into separate and equal power subsources such that there is one power splitter and one power subsource for each load element, wherein the power provided to each of the plurality of load elements is equal to the power of the electrical power source. In combination with the fault tolerant element, the plurality of load elements can include a first subzone and a second subzone, the first subzone including a first plurality of heating elements connected in series and the second subzone including a second plurality of heating elements connected in series. In addition, exemplary methods can optionally include proportioning the electrical power with time to match the electrical power to the power subsource to each of the plurality of load elements.

An exemplary circuit can be designed, constructed, and assembled. In one embodiment, a corrective circuit is inserted between a control system and two or more heating elements to provide a fault tolerant assembly for feeding multiple loads with a proportional power supply. While exemplary figures show two load elements or heating elements, more than two loads can be fed by exemplary embodiments, with each load receiving the same power as the power supply to the circuit. One feature of the circuit according to exemplary embodiments is a silicon control rectifier (SCR) that presents only half-wave AC to each load element section at fifty percent duty cycle. This feature presents the same resistance to both the positive and the negative half-cycles of the AC cycle, but only one element is energized during each half-cycle. This can be further illustrated by the following formula:

The effective power of a connection in series:
P=V²(2R)⁻¹×duty cycle

Where V=120 volts, R=10 ohms, and duty cycle is 100%.
P=120² ×(2×10)⁻¹ watts×100% duty cycle
P=14,400×(20)⁻¹ watts×100% duty cycle
P=720 watts

The effective power of a connection in parallel:
P=(V²(R)⁻¹)×duty cycle

Where V=120 volts, R=10 ohms, and duty cycle is 50%.
P=(120²×(10)⁻¹ watts×50% duty cycle
P=(14,400×(10)⁻¹) watts×50% duty cycle
P=(1440) watts×50% duty cycle
P=720 watts

In the parallel configuration, according to exemplary embodiments, only one resistance element is connected to the power source, through a corrective circuit such as a SCR, at a time. As shown above, the power remains constant for both the series and the parallel configuration, with the resistance per half remaining constant. Therefore the element wire selection for the parallel configuration can remain unchanged from the series circuit design, with the added benefit of redundancy for exemplary embodiments. Since the employed SCR solution is full wave, the load presented to the controller is still of Unity Power Factor. Current is drawn evenly on both the positive and negative AC half cycles. Element redundancy between the two halves yields fault tolerance where, if one half of the assembly fails, the other half remains in operation allowing the process to complete prior to being required to replace the failed heating element assembly and accordingly being able to avoid scrapping the work in process. It is normally possible to complete the process while running on only 50% of power as would be the case if one half of the element failed.

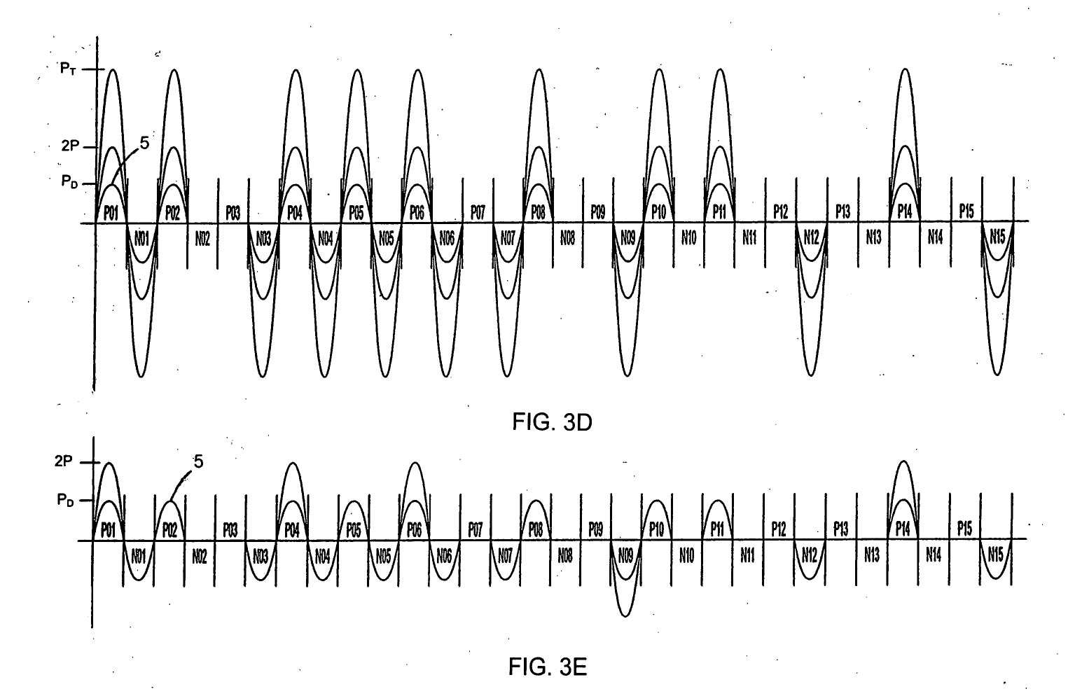

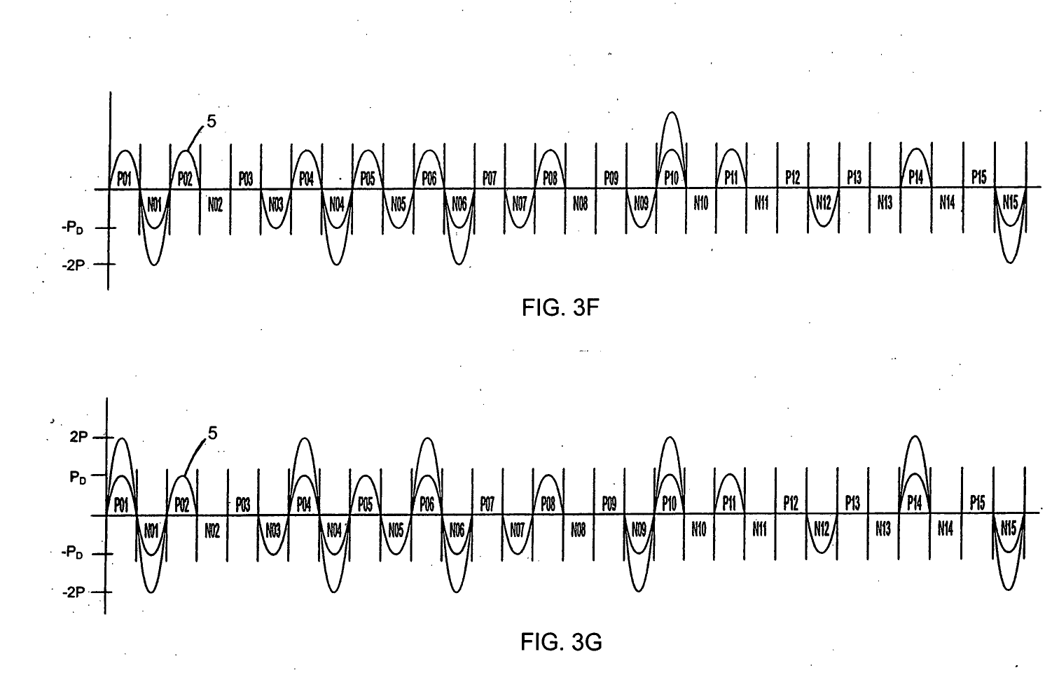

Referring now to FIG. 3, there is shown a graphical representation in the form of sine waves of power balancing by half-cycles for time proportional delivery of power to resistive loads. The graphs show power (P) as a function of time (t). For example, FIG. 3A graphically illustrates a typical AC power source with positive (P01, P02, P03 . . . Pn) half-cycles and negative (N01, N02, N03 . . . Nn) half-cycles. FIG. 3B represents the time proportional output 5 from the control system to the heating element. The graph illustrates the cycling of the output and represents the desired time-dependent power level (±P_{d}). FIG. 3B is reproduced in each of FIGS. 3C to 3G for reference. FIG. 3C shows an existing series connection where each of two element halves receive 50% of the power (±P_{1/2}) on all half-cycles (corresponding to the half-cycles of the control system output in FIG. 3B) so that the sum of the two halves equal the desired power ±P_{d} to the resistive element. FIG. 3D shows the effect of connecting two resistive elements in parallel without the corrective circuit of exemplary embodiments. Each half of the element would produce twice the desired power (±2P), such that the total power (±P_{T}) would be four times the target power level and would overload the circuit. FIG. 3E shows that with exemplary embodiments, one half of the element assembly would receive the first half-cycle P01 at twice the desired power, then would be off for the next three half-cycles N01, P02, N03 of the controlled output 5. FIG. 3F shows the second half of the element assembly, which would receive the second half-cycle N01, and then would be off for the next three half-cycles P02, N03, P04 of the controlled output 5. FIG. 3G shows time proportional power 10 balancing across half-cycles according to an exemplary embodiment, providing a total average power that is consistent with the original desired power level.

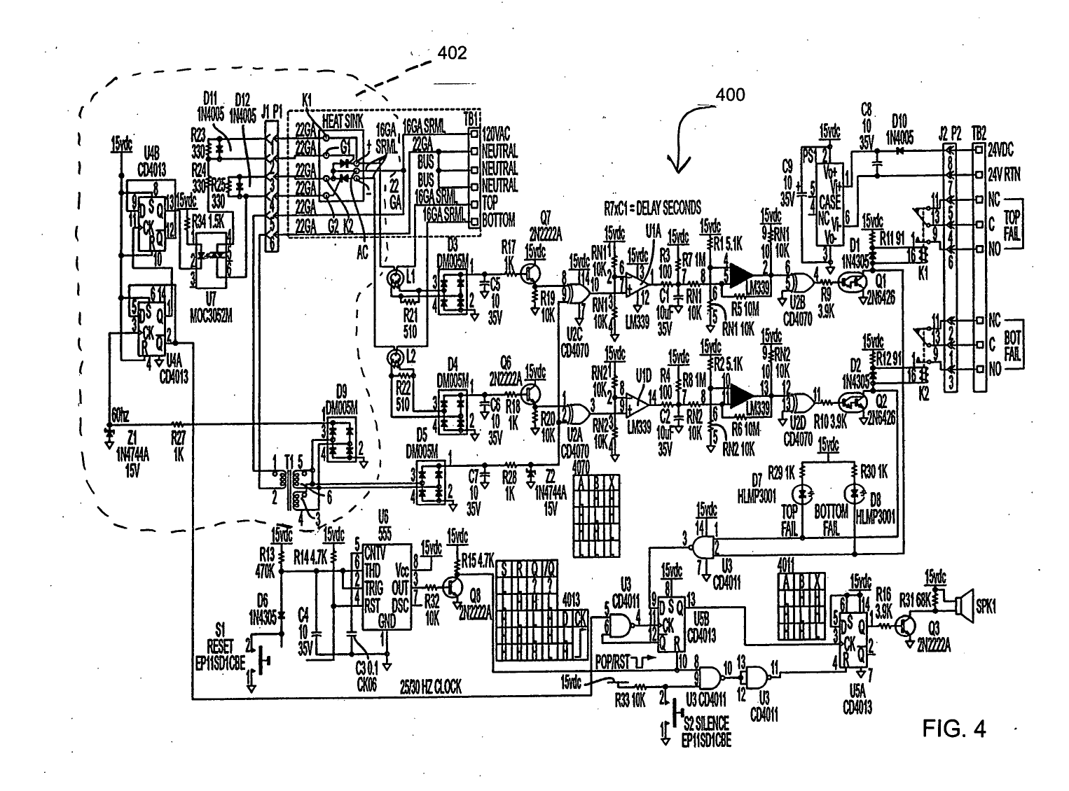

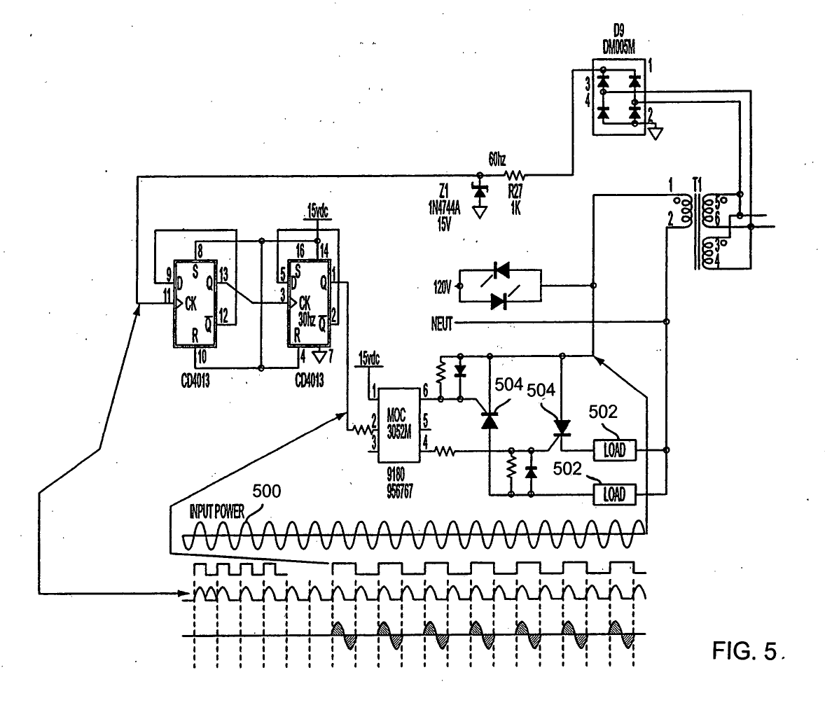

FIG. 4 is a schematic illustration of a exemplary circuit 200 constructed according to exemplary embodiments, and optional surrounding components of an assembly connected thereto. The circuit 400 includes an embodiment of the circuit for proportionally dividing an electrical load among a plurality of load sections 402 shown in FIG. 5. In addition, the circuit 400 includes fault detection circuitry, audible and visual alarm circuitry and reset circuitry.

FIG. 5 shows a conceptional schematic of an exemplary circuit for dividing a resistive load across a plurality of load elements in parallel. An input power supply or power source is shown at 500, wherein the input power supply is divided by half-cycles and applied across the exemplary loads 502. While only two resistive loads 502, such as heating elements, are shown in FIG. 5, more than two resistive loads can be accommodated by exemplary embodiments, with the input power supply divided into as many portions as there are load elements 502. The division of the power supply can be performed by corrective circuit according to an AC time proportional wave form. Alternately, the splitting of the power supply can be by AC phase control. The added silicon control rectifiers for allocating the divided power supply across the load elements 502 in parallel are shown at 504. For example, in integrating the assembly 200 of FIG. 2 into the circuit of FIG. 5, the first circuit path 212 could be one load element 502 and the second circuit path 214 could be the other load element 502, with the appropriate connectors 206, 208 for each connected to the FIG. 5 circuit.

Further enhancements to the illustrated circuit are contemplated and include independent alarms to indicate that an element has failed and which one. This provides a mechanism to alert a technician to the problem. Redundancy can be further enhanced by using this signal to select one of two thermocouples where each one would be installed in one section of the element assembly so as to give the best possible control feedback signal when operating on only one half of the heating element assembly.

Together, the fault tolerant element design disclosed herein and the fault tolerant control circuit disclosed in U.S. patent application Ser. No. 10/671,777 result in a fault tolerant combination. An exemplary fault tolerant combination can maintain the same net power output to the heating apparatus in event of a failure of a subzone because the power supply increases the supplied power to the remaining good subzones and the subzones are themselves intermingled in the heating apparatus so that the heating profile produced by a reduced number of subzones is still balanced.

An exemplary combination for a heating assembly in a heating furnace, comprises a fault tolerant element including an assembly of heating elements including a first plurality of heating elements connected in series forming a first subzone and a second plurality of heating elements connected in series forming a second subzone, wherein the heating elements of the first subzone are intermingled with the heating elements of the second subzone, and a fault tolerant control circuit including an electrical power source for providing electrical power to the first subzone and the second subzone, wherein the first subzone and the second subzone are connected in parallel to each other, and a plurality of power splitters for dividing the electrical power source into separate and equal power subsources such that there is one power splitter and one power subsource for each of the first subzone and the second subzone, wherein a time averaged sum of the power provided to the first subzone and the second subzone is equal to the power of the electrical power source.

Although described in connection with preferred embodiments thereof, it will be appreciated by those skilled in the art that additions, deletions, modifications, and substitutions not specifically described may be made without department from the spirit and scope of the invention as defined in the appended claims.

What is claimed is:

1. An assembly of heating elements comprising:
a first plurality of heating elements connected in series forming a first subzone; and
a second plurality of heating elements connected in series forming a second subzone,
wherein the heating elements of the first subzone are intermingled with the heating elements of the second subzone.

2. The assembly of claim 1, wherein the first plurality of heating elements and the second plurality of heating elements are arranged circumferentially about a process area.

3. The assembly of claim 2, wherein the first plurality of heating elements and the second plurality of heating elements arranged circumferentially form a cylinder.

4. The assembly of claim 3, wherein each of the first subzone and the second subzone are a portion of the cylinder.

5. The assembly of claim 2, wherein the first subzone and the second subzone are separated axially.

6. The assembly of claim 2, wherein the first subzone and the second subzone are separated radially.

7. The assembly of claim 2, wherein the first subzone and the second subzone are intermingled.

8. The assembly of claim 7, wherein the first subzone and the second subzone are interdigitated.

9. The assembly of claim 8, wherein the interdigitated subzones are in a regular pattern in an axial, radial or circumferential direction.

10. The assembly of claim 1, wherein a portion of the first subzone and a portion of the second subzone are contained within a common plane.

11. The assembly of claim 1, wherein all of the first subzone and all of the second subzone are contained within a common plane.

12. A heating furnace comprising:
an assembly of heating elements including a first plurality of heating elements connected in series forming a first subzone, and a second plurality of heating elements connected in series forming a second subzone,
wherein the heating elements of the first subzone are intermingled with the heating elements of the second subzone, and
wherein the first plurality of heating elements and the second plurality of heating elements are arranged about a process area of the heating furnace.

13. The heating furnace of claim 12, comprising:
a fault tolerant control circuit operatively connected to the assembly of heating elements, the fault tolerant control circuit including
an electrical power source for providing electrical power to the first subzone and the second subzone, wherein the first subzone and the second subzone are connected in parallel to each other, and
a plurality of power splitters for dividing the electrical power source into separate and equal power subsources such that there is one power splitter and one power subsource for each of the first subzone and the second subzone, wherein a time averaged sum of the power provided to the first subzone and the second subzone is equal to the power of the electrical power source.

14. The furnace of claim 12, wherein the first plurality of heating elements and the second plurality of heating elements are arranged circumferentially about the process area.

15. The furnace of claim 12, wherein the first plurality of heating elements and the second plurality of heating elements are arranged in a common plane.

16. A combination for a heating assembly in a heating furnace, comprising
a fault tolerant element including an assembly of heating elements including a first plurality of heating elements connected in series forming a first subzone and a second plurality of heating elements connected in series forming a second subzone, wherein the heating elements of the first subzone are intermingled with the heating elements of the second subzone; and
a fault tolerant control circuit including an electrical power source for providing electrical power to the first subzone and the second subzone, wherein the first subzone and the second subzone are connected in parallel to each other, and a plurality of power splitters for dividing the electrical power source into separate and equal power subsources such that there is one power splitter and one power subsource for each of the first subzone and the second subzone, wherein a time averaged sum of the power provided to the first subzone and the second subzone is equal to the power of the electrical power source.

17. The combination of claim 16, wherein the power splitting is performed according to an AC time proportional wave form.

18. The combination of claim 16, wherein the power splitting is performed according to AC phase control.

19. The combination of claim 16, including an alarm circuit for activating an alarm when one of the components of the circuit becomes out of specification.

20. The combination of claim 16, wherein the circuit proportions the electrical power source with time to match the electrical power to the power subsource to each of the first subzone and the second subzone.

21. The combination of claim 16, wherein the first plurality of heating elements and the second plurality of heating elements are arranged circumferentially about a process area.

22. The combination of claim 16, wherein the first subzone and the second subzone are intermingled.

23. The combination of claim 22, wherein the first subzone and the second subzone are interdigitated.

24. The combination of claim 23, wherein the interdigitated subzones are in a regular pattern in an axial, radial or circumferential direction.

25. The combination of claim 16, wherein a portion of the first subzone and a portion of the second subzone are contained within a common plane.

26. The combination of claim 16, wherein all of the first subzone and all of the second subzone are contained within a common plane.

27. A method for dividing an electrical resistive load among a plurality of load elements in parallel, comprising:
providing electrical power to a plurality of load elements, wherein the plurality of load elements are connected in parallel to each other; and
dividing the electrical power into separate and equal power subsources such that there is one power splitter and one power subsource for each load element,
wherein a time averaged sum of the power provided to the plurality of load elements is equal to the power of the electrical power source, and
wherein the plurality of load elements include a first subzone and a second subzone, the first subzone including a first plurality of heating elements connected in series and the second subzone including a second plurality of heating elements connected in series.

28. The method according to claim 27, including proportioning the electrical power with time to match the electrical power to the power subsource to each of the plurality of load elements.

29. The method of claim 27, wherein the first plurality of heating elements and the second plurality of heating elements are arranged circumferentially about a process area.

30. The method of claim 27, wherein the first subzone and the second subzone are intermingled.

31. The method of claim 30, wherein the first subzone and the second subzone are interdigitated.

32. The method of claim 31, wherein the interdigitated subzones are in a regular pattern in an axial, radial or circumferential direction.

33. The method of claim 27, wherein a portion of the first subzone and a portion of the second subzone are contained within a common plane.

34. The method of claim 27, wherein all of the first subzone and all of the second subzone are contained within a common plane.
